(19) United States
(12) Patent Application Publication
(10) Pub. No.: US 2026/0002269 A1
(43) Pub. Date: Jan. 1, 2026

(54) MEMBRANE ELECTRODE ASSEMBLY HAVING BIFUNCTIONAL CATALYSTS FOR FUEL CELLS AND ELECTROLYZERS

(71) Applicant: GM Global Technology Operations LLC, Detroit, MI (US)

(72) Inventors: Ruichun Jiang, Troy, MI (US); Swaminatha P. Kumaraguru, Rochester Hills, MI (US)

(21) Appl. No.: 18/760,153

(22) Filed: Jul. 1, 2024

(51) Int. Cl. C25B 9/23; B60L 50/72; C25B 11/032; C25B 11/036; C25B 11/065; C25B 11/067; C25B 11/081; H01M 4/86; H01M 4/92; H01M 8/10; H01M 8/1004

(52) U.S. Cl. CPC C25B 9/23; C25B 11/032; C25B 11/036; C25B 11/065; C25B 11/067; C25B 11/081; H01M 4/8631; H01M 4/926; H01M 8/1004; B60L 50/72; H01M 2004/8694; H01M 2008/1095; H01M 2250/20

(57) ABSTRACT

A membrane electrode assembly (MEA) for a fuel cell and an electrolyzer is provided. The MEA includes a first electrode layer, a second electrode layer disposed opposite the first electrode layer, a polymer electrolyte membrane extending between the first electrode layer and the second electrode layer, a gas diffusion layer (GDL) disposed adjacent the first and second electrode layers. A bifunctional catalyst comprising a noble metal supported on a metal oxide compound is disposed in at least one of polymer electrolyte membrane, first and second electrodes, and GDLs. The noble metal comprises at least one of Pt and Pd. The metal oxide compound comprises at least one of CeO₂, CexZr_{y}O₄, MnO₂, CeEO, MnEOx, and CoEOx. The ratio of the noble metal to the metal oxide compound is 1%-80% by weight.

### INTRODUCTION

The present disclosure relates to membrane electrode layer assemblies for fuel cells and electrolyzers, and more particularly to a membrane electrode assembly having bifunctional catalysts as mitigants for membrane degradation.

Electrochemical fuel cells are used as electrical power sources for electric vehicles. Electrochemical fuel cells, or simply as fuel cells, convert reactants in the form of fuel and oxidants into electricity. In one exemplary configuration, a fuel cell includes an anode layer, a cathode layer spaced from the anode layer, and a proton exchange membrane (PEM) separating the anode layer and cathode layer. A hydrogen-rich gas or pure hydrogen is supplied as fuel to the anode layer side of the fuel cell while oxygen is supplied to the cathode layer side. The anode layer and cathode layer form an electric circuit when a current flowing from the anode layer to the cathode layer is routed through a connected external load. The PEM prevents gas crossover and electric current flow but permits proton migration from the anode layer to the cathode layer.

Electrolyzers are devices that uses electrolysis to split water molecules into hydrogen and oxygen gases. Electrolyzers are complementary technology to fuel cells. In one exemplary configuration, an electrolyzer includes an electrolytic cell having a cathode layer, an anode layer, and a PEM separating the anode layer and the cathode layer. Electrolysis occurs when an electric energy is applied across the electrolytic cell. The anode layer strips the positive charged hydrogen ions (H+) from water and releases oxygen gas (O₂). The cathode layer attracts the positively charged hydrogen ions (H+) and releases hydrogen gas (H₂).

Fuel cells and electrolyzers typically have a membrane electrode assembly (MEA) that includes an ionically conductive polymer membrane disposed between an anode layer and a cathode layer. Protons flow between the anode layer and cathode layer through the ionically conductive polymer membrane. The anode layer and cathode layer are formed of porous conductive materials, such as woven graphite, graphitized sheets, or carbon paper to enable the fuel/water to disperse over the surface of the polymer membrane facing the fuel/water supply electrode layer. One or more of the electrode layers has finely divided catalyst particles, such as platinum supported on carbon particles.

Durability is one of the factors that determine the commercial viability of a fuel cell and an electrolyzer. The MEA are known to degrade due to reactions with reactive species such as radicals formed as a side product during normal fuel cell or electrolyzer operations. Accordingly, there is a need for an improved degradation resistant MEA for fuel cell and electrolyzer applications.

### SUMMARY

According to several aspects, a membrane electrode assembly (MEA) is disclosed. The MEA includes a first electrode layer, a second electrode layer disposed opposite the first electrode layer, a polymer electrolyte membrane extending between the first electrode layer and the second electrode layer, and a bifunctional catalyst comprising a noble metal supported on a metal oxide compound is disposed in the polymer electrolyte membrane. The noble metal includes at least one of platinum (Pt) and palladium (Pd). The metal oxide compound includes one or more Cerium Oxide (CeO₂), Cerium Zirconium oxide (CeₓZr_{y}O₄), Manganese Dioxide (MnO₂), Cerium E Oxide (CeEO), Manganese E Oxide (MnEOₓ), and Cobalt E Oxide (CoEOₓ), wherein E stands for one or more metal or non-metal elements.

In an additional aspect of the present disclosure, the ratio of the noble metal to the metal oxide compound by weight is from 1:99 to 80:20.

In another aspect of the present disclosure, the bifunctional catalyst may be homogenously or non-uniformly disposed in the polymer electrolyte membrane.

In another aspect of the present disclosure, the first electrode includes a catalyst blend including the bifunctional catalyst and a platinum on carbon (Pt/C) catalyst. The catalyst blend includes 1 wt % to 60 wt % of the bifunctional catalyst and a remaining wt % of the Pt/C catalyst.

In another aspect of the present disclosure, the polymer electrolyte membrane is disposed in a fuel cell in a vehicle and includes a concentration of 1 ug/cm² to 200 ug/cm² of the bifunctional catalyst.

In another aspect of the present disclosure, the polymer electrolyte membrane is disposed in an electrolyzer and includes a concentration of 10 to 2000 ug/cm² of the bifunctional catalyst.

According to several aspects, a fuel cell for a vehicle is disclosed. The fuel cell includes an anode layer, a cathode layer, a polymer electrolyte membrane extending between the anode layer and the cathode layer, and a bifunctional catalyst disposed in the polymer electrolyte membrane. The bifunctional catalyst includes a noble metal supported on a metal oxide compound. The noble metal comprises at least one of Pt and Pd. The metal compound includes at least one of CeO₂, CeₓZr_{y}O₄, MnO₂, CeEO, MnEOₓ, and CoEOₓ.

In an additional aspect of the present disclosure, the bifunctional catalyst is non-uniformly distributed in the polymer electrolyte membrane.

In another aspect of the present disclosure, the bifunctional catalyst in the polymer electrolyte membrane includes a ratio of Pt to CeO₂ in the range of 1%-80% by weight.

In another aspect of the present disclosure, the anode layer includes a catalyst blend formed of the bifunctional catalyst and a platinum on carbon (Pt/C) catalyst. The catalyst blend includes 1 wt % to 60 wt % of the bifunctional catalyst and a remaining wt % of the Pt/C catalyst.

In another aspect of the present disclosure, the polymer electrolyte membrane includes a concentration of the bifunctional catalyst of 1-200 ug/cm².

According to several aspects, an electrolyzer is disclosed. The electrolyzer includes an anode layer, a cathode layer, a polymer electrolyte membrane extending between the anode layer and the cathode layer, and a bifunctional catalyst disposed in the polymer electrolyte membrane. The bifunctional catalyst comprises a noble metal supported on a metal oxide compound.

In an additional aspect of the present disclosure, the noble metal comprises at least one of Pt and Pd. The metal oxide compound comprises at least one of CeO₂, CeₓZr_{y}O₄, MnO₂, CeEO, MnEOₓ, and CoEOₓ; wherein E stands for one or more metal or non-metal elements and x depends on the oxidation state of E.

In another aspect of the present disclosure, the polymer electrolyte membrane includes a concentration of the bifunctional catalyst of 10 ug/cm² to 2000 ug/cm²

In another aspect of the present disclosure, the electrolyzer further includes a gas diffusion layer disposed adjacent to at least one of the anode layer and the cathode layer, in which the gas diffusion layer includes the bifunctional catalyst.

In another aspect of the present disclosure, the anode layer comprises an IrOₓ catalyst.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a diagrammatic representation of a vehicle having an energy conversion device, such as a fuel cell, containing a membrane electrode assembly (MEA), according to an exemplary embodiment;

FIG. 2 is diagrammatic representation of a cross-section of a membrane electrode assembly (MEA) configurable for use in a fuel cell and electrolyzer, according to an exemplary embodiment;

FIG. 2A is diagrammatic representation of a bifunctional catalyst, according to an exemplary embodiment;

FIG. 3 is diagrammatic representation of a cross-section of a fuel cell having the membrane electrode assembly (MEA), according to an exemplary embodiment; and

FIG. 4 is diagrammatic representation of a cross-section of an electrolyzer having the membrane electrode assembly (MEA), according to an exemplary embodiment.

### DETAILED DESCRIPTION

The following description is merely exemplary in nature and is not intended to limit the present disclosure, application, or uses. The illustrated embodiments are disclosed with reference to the drawings, wherein like numerals indicate corresponding parts throughout the several drawings. The figures are not necessarily to scale and some features may be exaggerated or minimized to show details of particular features. The specific structural and functional details disclosed are not intended to be interpreted as limiting, but as a representative basis for teaching one skilled in the art as to how to practice the disclosed concepts.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers, and/or sections. These elements, components, regions, layers, and/or sections should not be limited by these terms. These terms may be only used to distinguish one element, component, region, layer or section from another region, layer, or section. Terms such as “first,” “second,” and other numerical terms do not imply a sequence or order unless clearly indicated by the context. Thus, a first element, component, region, layer, or section discussed below could be termed a second element, component, region, layer, or section without departing from the teachings of the example configurations.

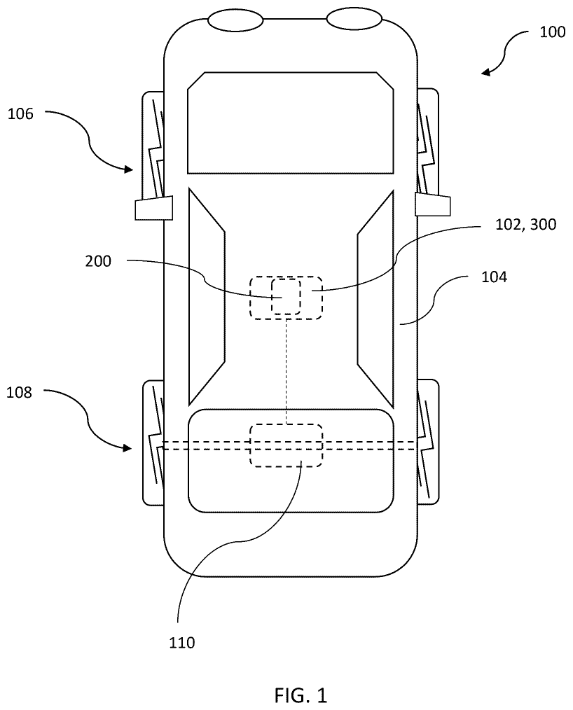

FIG. 1 is a diagrammatic illustration of a non-limiting example of a vehicle 100 having an energy conversion device 102 containing a membrane electrode assembly 200. The vehicle 100 generally includes a body 104 having front wheels 106 and rear wheels 108. The front wheels 106 and the rear wheels 108 are each rotationally located near a respective corner of the body 104. At least one of the front wheels 106 and the rear wheels 108 is propelled by an engine 110 powered directly or indirectly by the energy conversions device 102.

In one non-limiting embodiment, the engine 110 is an electric motor and the energy conversion device 102 is a fuel cell 300 configured to convert a hydrogen rich fuel and oxygen from the ambient air into electricity to power the electric motor. While the vehicle 100 is depicted in the illustrated embodiment as a passenger car, other examples of vehicles include, but are not limited to, motorcycles, trucks, sport utility vehicles (SUVs), recreational vehicles (RVs), marine vessels, and aircraft. While the membrane electrode assembly 200 is shown as part of the fuel cell 300, the membrane electrode assembly 200 is also configurable for use in an electrolyzer 400, which is disclosed in detail below.

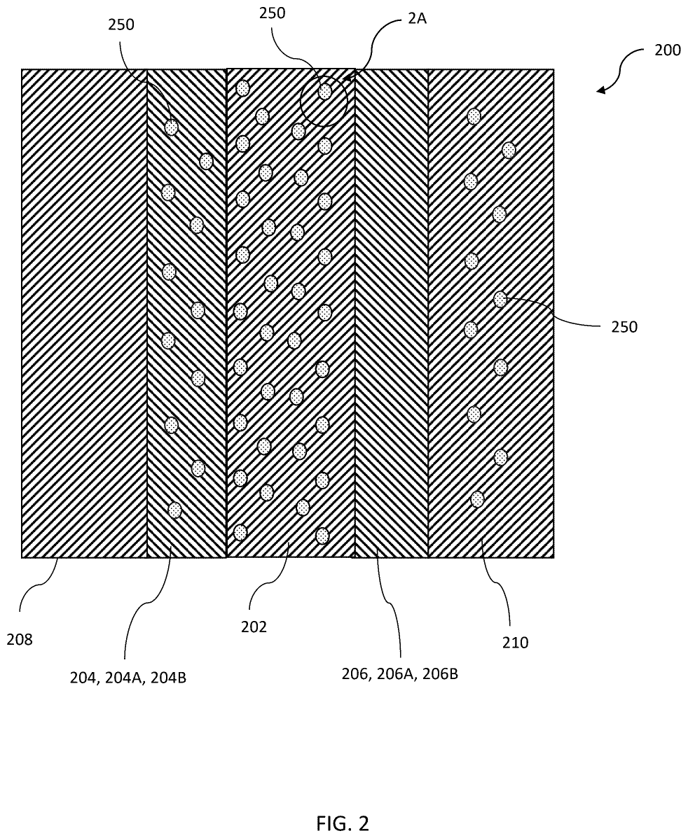

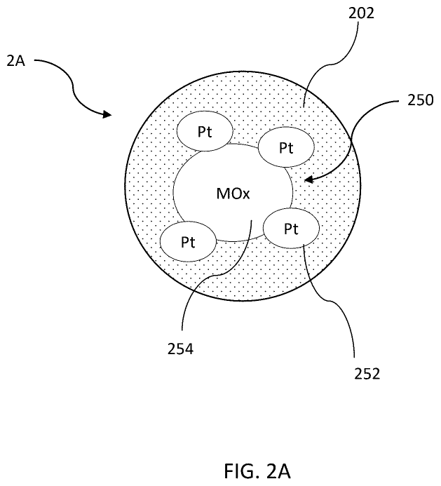

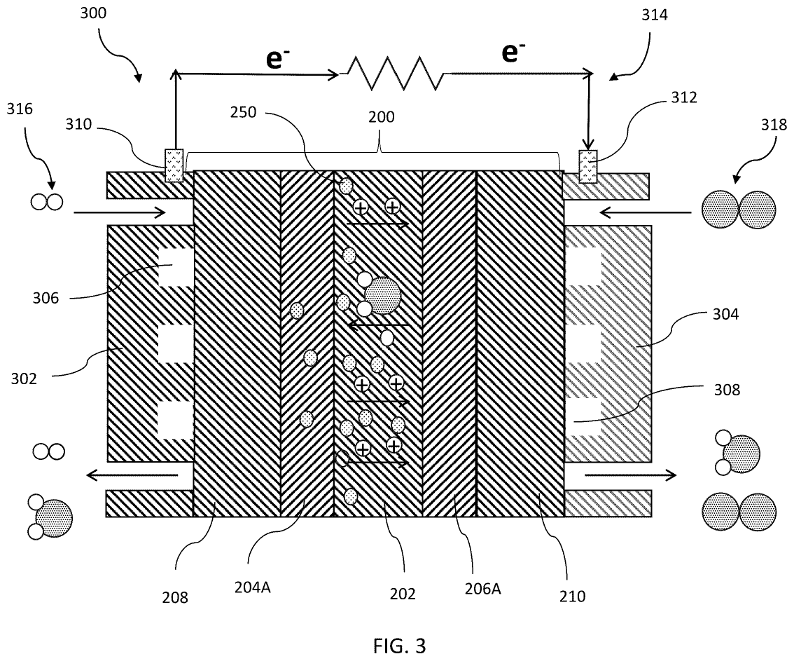

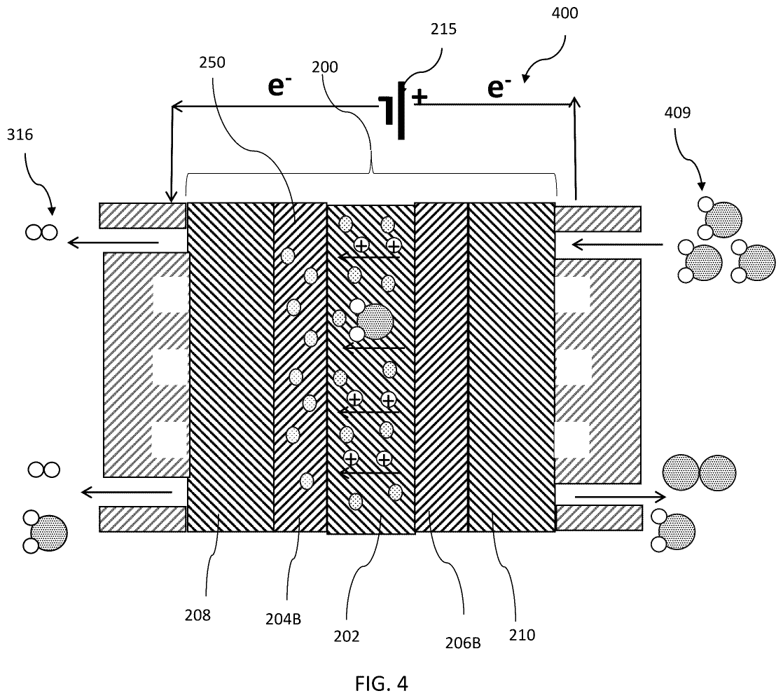

FIG. 2 is a diagrammatic illustration of a non-limiting example of the membrane electrode assembly (MEA) 200 configurable for used in a fuel cell 300 and electrolyzer 400, as shown in FIG. 3 and FIG. 4 respectively. The MEA 200 includes a polymer electrolyte membrane 202 disposed between a first electrode layer 204 and a second electrode layer 206. At least one of the first electrode layer 204 and the second electrode layer 206 is typically formed from a nanoparticle metal catalyst bound together with an ion conducting polymer. The ion conducting polymer may be similar to the ion conducting polymer used in the polymer electrolyte membrane 202, which is disclosed in detail below. Non-limiting examples of the nanoparticle metal catalyst include platinum (Pt) supported on carbon (C), also referred to as a Pt/C catalyst or Pt/C, and an iridium oxide (IrOₓ) catalyst.

Adjacent to the first electrode layer 204 is a first porous substrate layer 208 that facilitates gas and fluid transport. Similarly, adjacent to the second electrode layer 206 is a second porous substrate layer 210 that also facilitates gas and fluid transport. The first and second porous substrate layers 208, 210 are also referred to as first and second gas diffusion layers (GDL) 208, 210. The first and second GDL 208, 210 may be made of nonwoven carbon paper. Referring to FIG. 2 and FIG. 3, the MEA 202 is shown in a configuration for use in a fuel cell 300. In the fuel cell configuration, the first electrode layer 204 is an anode layer 204A and the second electrode layer 206 is a cathode layer 206A. Referring to FIG. 2 and FIG. 4, the MEA is shown in a configuration for use in an electrolyzer 400. In the electrolyzer configuration, the first electrode layer 204 is a cathode layer 204B and the second electrode layer 206 is an anode layer 206B, which may contain an IrOₓ catalyst.

The polymer electrolyte membrane 202 serves as a conductor for proton flow between the first electrode layer 204 and second electrode layer 206. Additionally, the MEA in a fuel cell configuration, the polymer electrolyte membrane 202 serves as an insulator for electrons (e⁻) to flow through an external circuit 314. The polymer electrolyte membrane 202 may be comprised of a fluoropolymer proton permeable electrical insulator barrier. Alternatively, the polymer electrolyte membrane may be comprised of a hydrocarbon proton permeable electrical insulator barrier. Moreover, the polymer electrolyte membrane may be comprised of a sulfonic acid ionomer.

During operation of the fuel cell 300 or electrolyzer 400, hydrogen peroxide may be formed on at either of the first and second electrode layers 204, 206 and migrates into the polymer electrolyte membrane 202. Also, hydroxyl radicals can be directly formed at either electrode layers 204, 206 or it can be produced indirectly from hydrogen peroxide via metal ion (i.e. Fe²⁺) catalyzed decomposition. The combination of hydroxyl radical and hydrogen peroxide is effective at damaging the polymer electrolyte membrane 202, leading to a loss of durability of the polymer electrolyte membrane 202.

A bifunctional catalyst 250 may be disposed in the polymer electrolyte membrane 202, in the first electrode layer 204, the second electrode layers 206, the first GDL 208, and/or the second GDL 210 to reduce the concentration of harmful hydrogen peroxide and its radicals. The functions of the bifunctional catalyst 250 is determined by its material composition as well as the interaction between its material composition. Best shown in FIG. 2A, the bifunctional catalyst 250 comprises of a noble metal 252 supported on a metal oxide compound 254. The noble metal 252 enhances the reaction efficiency of the metal oxide compound 254 to decompose harmful byproducts such as hydroxyl radical or hydrogen peroxide, in turn improving the durability of the polymer electrolyte membrane 202.

Referring to FIG. 2A, the noble metal 252 includes Platinum (Pt) and/or Palladium (Pd). The metal oxide compound 254 (MOₓ) is selected from the group consisting of CeO₂, CeₓZr_{y}O₄, MnO₂, CeEO, MnEOₓ, and CoEOₓ. Wherein E stands for one or more metal or non-metal elements and x depends on the oxidation state of E. A bifunctional catalyst comprising of Pt on a metal oxide compound may be expressed as Pt/MOₓ. More specifically, Pt on CeO₂ may be expressed as Pt/CeO₂. The ratio of noble metal to metal oxide (e.g. weight ratio of Pt to CeO₂) can be in the range of 1% to 80% by weight (wt %). For example, 1 wt % Pt and 99% CeO₂ (1:99) as the lower limit, and 80 wt % Pt and 20 wt % CeO₂ (80:20) as the upper limit.

In a non-limiting example, the polymer electrolyte membrane 202 includes a bifunctional catalyst comprising of Pt on CeO₂ (Pt/CeO₂). The Pt provide electron rich environment to CeO₂ which helps enhance Ce⁴⁺/Ce³⁺ redox reaction cycle during harmful byproducts of hydroxyl radical (OH·) scavenging and hydrogen peroxide (H₂O₂) decomposing. The Pt has the function of reacting crossed-over H₂ and O₂ into water thus reducing the crossover rate of the two gases. The CeO₂ works as a byproduct scavenger to prevent the byproducts from chemically degrading the membrane 202. The concentration of the bifunctional catalyst 250 in the polymer electrolyte membrane 202 depends on several factor like membrane thickness, etc. In a non-limiting example, the polymer electrolyte membrane 202 may include a concentration of 1 ug/cm² to 200 ug/cm² of the bifunctional catalyst for fuel cell application and 10 ug/cm² to 2000 ug/cm² of the bifunctional catalyst 250 for electrolyzer applications. In a non-limiting example, the polymer electrolyte membrane 202 includes 0.1 to 20 weight percent (wt %) of the bifunctional catalyst 250, preferably Pt/CeO₂.

In other non-limiting example, the fuel cell anode 204A or electrolyzer cathode 204B comprises Pt/CeO₂. The Pt works as electrocatalyst to oxide H₂ into H⁺ (fuel cell), or reduce H₂O into H₂ (electrolyzer), while the CeO₂ works as by-products (e.g., H₂O₂, OH·) scavenger to prevent membrane degradation. Also in the fuel cell anode 204A or electrolyzer cathode 204B, the H₂O₂ is likely to be generated as a byproduct. With the CeO₂ at the fuel cell anode 204A or electrolyzer cathode 204B, the H₂O₂ can be rapidly killed at its source location of generation. In a non-limiting example, one or both of the electrode layers 204, 206 may include the bifunctional catalyst 250, preferably Pt/CeO₂. The bifunctional catalyst 250 is typically 1% to 60% by weight of the total catalyst weight, which may include Pt/C or IrOₓ, in the electrode layer 204, 206.

The bifunctional catalyst 250 (i.e. Pt/MOₓ) can be incorporated into the membrane by a solution coating process. In a non-limiting example, the Pt/MOₓ is dispersed in a ionomer solution followed by casting of ionomer solution to form the membrane. The membrane 202 may be formed by coating multiple layers, in which the Pt/MOₓ are disposed into the selected layers during the coating process to control the location and concentration of the Pt/MOₓ within the completed membrane 202.

Pt/MOₓ in the first and second electrode layers 204, 206 can be made by ink dispersion and followed by coating process. The Pt/MOₓ can be mixed/blended with other catalysts (e.g., Pt/C), in which preferably 1 wt % to 60 wt % of the total catalyst blend is Pt/MOₓ, together with other additives such as ionomer binder for proton conduction in electrodes, alcohol and water as dispersion solvent. Usually a milling process is needed to disperse the ink obtained above to achieve uniform dispersion. After that the ink can be coated using various methods (e.g., slot die coating, blade coating) on different substrates (e.g., gas diffusion layer, microporous layer, decal substrate). The obtained electrode layers is then applied onto the membrane using various methods.

The exemplary fuel cell 300 shown in FIG. 3 comprises current collector plates 302, 304, also referred to as bipolar plates 302, 304, having respective gas flow channels 306, 308 to facilitate gas distribution, anode electrical connector 310, cathode electrical connector 312, and the membrane electrode assembly 200 is configured for use in the fuel cell 300. Anode connector 310 and cathode connector 312 are used to interconnect with an external circuit 314, which may be connected to the electric engine 110 of the vehicle 100. The fuel cell 300 receives reactant gases, one of which is a hydrogen rich fuel 316 supplied from a fuel source, and another of which is an oxidizer gas 318 supplied from an oxidizer gas source. The hydrogen rich fuel may be hydrogen gas and the oxidizer gas source may be pure oxygen or oxygen from the ambient air. The hydrogen rich fuel 316 and oxidizer gas 318 are routed via the channels 306, 308 of the respective bipolar plates 302, 304 and diffused through the porous substrate layers 208, 210 to opposite sides of the MEA 200 for electrochemical reactions to generate electricity.

The membrane electrode assembly 200, configured for use in the fuel cell 300, includes the bifunctional catalyst 250 disposed in the polymer electrolyte membrane 202, anode layer 204A, cathode layer 206A, and/or GDLs 208, 210. The distribution of the bifunctional catalyst in the membrane can be uniform or non-uniform. In a non-limiting example shown, the bifunctional catalyst 250 is non-uniformly distributed in the polymer electrolyte membrane 202 and anode 204A. In a non-limiting example, the anode layer 204A includes a catalyst blend/mixture comprising 1 wt % to 60 wt % of Pt/MOₓ and a remainder of Pt/C.

FIG. 4 is a diagrammatic illustration of a non-limiting example of an electrolyzer 400 having a MEA 200 configured for use in the electrolyzer 400. The cathode layer 204B is disposed on one end of the polymer electrolyte membrane 202 and the anode layer 206B is disposed on an opposite end of the polymer electrolyte membrane 202. The first porous substrate layer 208, or first GDL 208, is negatively charged by which electrons (e) enter the MEA 200 and within which a hydrogen gas 316 generated from hydrogen evolution reaction at cathode layer 204B is transported. Additionally, the anode layer 206B includes a positively charged second porous substrate layer 210, or second GDL 210, in which water 409 is oxidized to evolve oxygen. Hydrogen protons (H⁺) migrate across the polymer electrolyte membrane 202 to reach the cathode layer 204B. The GDLs 208, 210 are configured to facilitate gas and fluid transport to or from the respective cathode 204B and anode layer 206B. The GDL 208, 210 may be made of nonwoven carbon paper and in some cases consist of a carbon layer named microporous layers (MPL). Additionally, in the electrolyzer configuration, the gas diffusion layer 210 adjacent to the anode electrode 206 is composed of corrosion resistant titanium oxide.

The membrane electrode assembly 200, configured for use in the electrolyzer, includes the bifunctional catalyst 250 disposed primarily in the polymer electrolyte membrane 202 and in the cathode layer 204B. The distribution of the bifunctional catalyst in the membrane can be uniform or non-uniform. In a non-limiting example shown, the bifunctional catalyst is non-uniformly distributed in the polymer electrolyte membrane 202 and the cathode layer 204B, and an IrOₓ is disposed in the anode layer 206B.

Numerical data have been presented herein in a range format. “The term “about” as used herein is known by those skilled in the art. Alternatively, the term “about” includes +/−0.5%” of stated value. It is to be understood that this range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. While examples have been described in detail, those familiar with the art to which this disclosure relates will recognize various alternative designs and examples for practicing the disclosed method within the scope of the appended claims.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A membrane electrode assembly comprising:
a first electrode layer;
a second electrode layer disposed opposite the first electrode layer;
a polymer electrolyte membrane extending between the first electrode layer and the second electrode layer; and
a bifunctional catalyst comprising a noble metal supported on a metal oxide compound is disposed in the polymer electrolyte membrane.

2. The membrane electrode assembly of claim 1, wherein the noble metal comprises at least one of platinum (Pt) and palladium (Pd).

3. The membrane electrode assembly of claim 2, wherein the metal oxide compound comprises at least one of Cerium Oxide (CeO₂), Cerium Zirconium oxide (CeₓZr_{y}O₄), Manganese Dioxide (MnO₂), Cerium E Oxide (CeEO), Manganese E Oxide (MnEOₓ), and Cobalt E Oxide (CoEOₓ), wherein E stands for one or more metal or non-metal elements.

4. The membrane electrode assembly of claim 3, wherein the noble metal to the metal oxide compound includes a ratio by weight from 1:99 to 80:20.

5. The membrane electrode assembly of claim 1, wherein the bifunctional catalyst is homogenously disposed in the polymer electrolyte membrane.

6. The membrane electrode assembly of claim 1, wherein the bifunctional catalyst is non-uniformly disposed in the polymer electrolyte membrane.

7. The membrane electrode assembly of claim 3, wherein the first electrode includes a catalyst blend comprising of the bifunctional catalyst and a platinum (Pt) on carbon (C) catalyst (Pt/C catalyst); and
wherein the catalyst blend comprises 1 wt % to 60 wt % of the bifunctional catalyst and a remaining wt % of the Pt/C catalyst.

8. The membrane electrode assembly of claim 5, wherein the polymer electrolyte membrane is disposed in a fuel cell and includes a concentration of 1 ug/cm² to 200 ug/cm² of the bifunctional catalyst.

9. The membrane electrode assembly of claim 8, wherein the fuel cell is disposed within a vehicle having an electric engine.

10. The membrane electrode assembly of claim 5, wherein the polymer electrolyte membrane is disposed in an electrolyzer and includes a concentration of 10 to 2000 ug/cm² of the bifunctional catalyst.

11. A fuel cell for a vehicle comprising:
an anode layer;
a cathode layer;
a polymer electrolyte membrane extending between the anode layer and the cathode layer; and
a bifunctional catalyst disposed in the polymer electrolyte membrane;
wherein the bifunctional catalyst comprises a noble metal supported on a metal oxide compound;
wherein the noble metal comprises at least one of Pt and Pd;
wherein the metal oxide compound comprises at least one of CeO₂, CeₓZr_{y}O₄, MnO₂, CeEO, MnEOₓ, and CoEOₓ;
wherein the bifunctional catalyst in the polymer electrolyte membrane includes a ratio of Pt to CeO₂ in a range of 1%-80% by weight;
wherein the anode layer comprises a catalyst blend comprising of the bifunctional catalyst and a platinum on carbon (Pt/C) catalyst; and
wherein the catalyst blend comprises 1 wt % to 60 wt % of the bifunctional catalyst and a remaining wt % of the Pt/C catalyst.

12. The fuel cell of claim 11, wherein the bifunctional catalyst is non-uniformly distributed in the polymer electrolyte membrane.

13. The fuel cell of claim 12, wherein the cathode layer comprises a catalyst blend comprising of the bifunctional catalyst and a platinum on carbon (Pt/C) catalyst.

14. The fuel cell of claim 12, wherein the polymer electrolyte membrane includes a concentration of the bifunctional catalyst of 1-200 ug/cm².

15. The fuel cell of claim 12, wherein the fuel cell is configured to power an electric engine.

16. An electrolyzer comprising:
an anode layer;
a cathode layer;
a polymer electrolyte membrane extending between the anode layer and the cathode layer; and
a bifunctional catalyst disposed in the polymer electrolyte membrane; and
wherein the bifunctional catalyst comprises a noble metal supported on a metal oxide compound.

17. The electrolyzer of claim 16:
wherein the noble metal comprises at least one of Pt and Pd; and
wherein the metal oxide compound comprises at least one of CeO₂, CeₓZr_{y}O₄, MnO₂, CeEO, MnEOₓ, and CoEOₓ; wherein E stands for one or more metal or non-metal elements and x depends on the oxidation state of E.

18. The electrolyzer of claim 16, wherein the polymer electrolyte membrane includes a concentration of the bifunctional catalyst of 10 ug/cm²-2000 ug/cm².

19. The electrolyzer of claim 16, further comprising a gas diffusion layer disposed adjacent to at least one of the anode layer and the cathode layer, wherein the gas diffusion layer includes the bifunctional catalyst.

20. The electrolyzer of claim 16, wherein the anode layer comprises an IrOₓ catalyst.
